(19) United States
(12) Patent Application Publication
(10) Pub. No.: US 2008/0156414 A1
(43) Pub. Date: Jul. 3, 2008

(54) Method and System for Repair of Glass

(76) Inventors: Richard Campfield, Grand Junction, CO (US); Kerry Wanstrath, Durango, CO (US)

Correspondence Address: Lawrence S. Cohen, 10960 Wilshire Boulevard, Suite 1220, Los Angeles, CA, 90024, US

(21) Appl. No.: 11/969,202

(22) Filed: Jan. 3, 2008

Related U.S. Application Data
(60) Provisional application No. 60/878,244, filed on Jan. 3, 2007.
(60) Provisional application No. 60/905,429, filed on Mar. 7, 2007.

(51) Int. Cl. B32B 43/00

(52) U.S. Cl. 156/94

(57) ABSTRACT

A pre-treatment chemical mixture of hydrofluoric acid or ammonium bifluoride and isopropyl alcohol for glass adhesive applications. In one particular a pretreatment for the repair of stone breaks and long cracks in windshields. The pretreatment improves the repair by removing, through evaporation of the solvent, isopropyl alcohol, the hydrophobic coating that has been applied to the windshield when it was manufactured and simultaneously etching the sides of the stone break or long crack in a way that allows better adhesion by the adhesive repair resin while not leaving any trace of the etching after the repair is complete, thereby keeping the windshield or other glass, clear.

### RELATED APPLICATIONS

This application is related to provisional application Ser. No. 60/878,244 filed on Jan. 3, 2007 and to provisional application Ser. No. 60/905,429 filed on Mar. 7, 2007 the priority benefit of both of which is claimed and the content of which are incorporated herein by reference.

### TECHNICAL FIELD

The present invention pertains to chemical pretreatment solutions and methods for use in the process of repairing glass and especially for the repair of windshields.

### BACKGROUND ART

Background art is found in U.S. Pat. Nos. 5,116,441; 5,425,827; 5,429,692; 5,512,116; 5,589,018; 5,614,046; 5,653,497; 5,860,689; 6,033,507 and 6,187,124. all of whose content is incorporated herein by reference.

A good explanation of the technology can be found in U.S. Pat. No. 5,614,046 (and also in U.S. Pat. Nos. 5,589,018 and 5,512,116). Some of that content is set out and summarized below.

Various resin products are commercially available in the trade for the repair of glass cracks and, in particular, the repair of automobile windshield breaks and cracks. Such repairs may be done in place without removal of the windshield and saves the cost of windshield replacement. The practicality of an acceptable glass crack repair is principally due to the fact that the index of refraction of the resin is substantially the same as that of the glass and the bond is able to restore the structural integrity of the glass and prevent the damage from spreading. These repairs are able to pass the same Federal Motor Vehicle Safety Standard tests as a new windshield such as FMVSS 205

A crack in glass is visible because as light rays pass the boundary between the glass and the air in the crack, they are bent due to the difference in the speed of light in glass as compared with the speed in air. Light that is reflected back from such boundaries comes at a different angle than if there were no crack and hence the eyes and brain of the observer sense the discontinuity. The index of refraction for any material is a ratio of the speed of light in that material compared to the speed in a vacuum. If two materials have the same index of refraction there will be no bending of the light rays at a boundary between the materials and an observer will not sense the discontinuity. Thus a crack filled with a resin that has the same index of refraction as the glass will essentially seem to disappear.

There are different formulations of resins. Some are aerobic or “air drying” and others are cured or hardened by radiating them with ultraviolet light which is usually provided by a lamp made for this purpose. The windshield repair industry favors UV curing adhesives. The aerobic resins come in two parts and are mixed before their use. Their curing begins from the time of mixing whereas the cure of the ultraviolet types begins when they are subjected to the ultraviolet light. The advantages of UV curing is that the curing process is able to be controlled so that it can begin when the technician has totally filled the break or crack with the resin. The aerobic resins may commence to cure before the technician is finished and ruin the repair.

Automobile windshields are made of a “sandwich” of two layers of glass laminated to an inner layer of resin material such as polyvinyl butyral (PVB). The windshield has a periphery which defines a glass area within the periphery for each glass layer. The glass area for each layer has an exposed surface and an inner surface in contact with the inner plastic (polyvinyl butyral) layer. Also, for each glass layer there is an edge defined by the periphery extending between the outer surface and the inner surface joining these surfaces at an angle such as 90 degrees to form a corner. Many types of breaks may occur in such windshields. The outside glass layer is called the “outerlite” and the inside glass layer is called the “innerlite”

There are two broad categories of cracks in windshields. One category is called a “stone break” and the other is called a “long crack”. These are clearly distinguished in the field as noted in patents listed above. One type of stone break, which is usually caused by the impact of a rock, is called a “bullseye”. A bullseye is a type of a stone break which has a circular appearance. It often has a cone shaped piece of glass detached from the outer layer. The apex of the cone faces the outer surface and the base of the cone may be forced partly into the inner layer. The apex may or may not connect to the outer atmosphere.

Sometimes the impact of a rock or other object will result in another type of stone break defined by small radiating cracks from the impact point, called a “star break”. A combination break can also occur, which is a “bullseye” with a “star” within the “bullseye”. Long cracks, that is cracks over 6 inches in length may also occur may extend to the glass edge or they may terminate at another point.

Various tools have been proposed to aid in filling stone breaks with resin. One is described in U.S. Pat. No. 3,993,520 to Werner and utilizes an injector assembly having a piston inside a cylinder. Another is described in U.S. Pat. No. 5,512,116 to Campfield. When the piston is depressed the resin is injected out the open end of the cylinder and into the stone break. The assembly is held to the surface of the glass by suction cups.

A similar apparatus with an adjustable arm is disclosed in U.S. Pat. No. 4,291,866 to Petersen. A variation of the Werner apparatus is in U.S. Pat. No. 4,569,808 to Smali while U.S. Pat. No. 4,744,841 to Thomas utilizes vibration and heat. An apparatus with a spring loaded air exit is disclosed in U.S. Pat. No. 4,775,305 to Alexander and U.S. Pat. No. 4,814,185 to Jones has a side tube for introduction of the resin. The use of vacuum to aid the resin injection is explored in U.S. Pat. No. 4,820,148 to Anderson and U.S. Pat. No. 4,919,602 to Janszen. Other related patents are U.S. Pat. No. 4,419,305 to Matles and U.S. Pat. No. 4,385,879 to Wilkinson

There are windshield repair apparatus of a number of different designs. In each case the objective has been to repair a stone break by use of vacuum and injection of resin by pressure. One type of system uses air pumps and compressors. However, the simplest and most effective type of system is a piston and cylinder arrangement. For example in the Werner U.S. Pat. No. 3,993,520 mentioned above, an injector is described which has an outer housing with an interior recess in which a rubber sleeve is mounted. The rubber sleeve is taught to be used to seal against the windshield for desired sealing by means of a protruding end portion. The injector also has a pressure screw which is inserted inside the housing. Inside the housing are threads which mate with threads on the pressure screw. Also, the pressure screw as a plunger end that fits the sleeve. Both the housing and the pressure screw have knurled handles, the first for setting up the apparatus, the second for injecting resin in the break.

For a normal bullseye type stone break approximately 1 cc of resin is needed, according to the Werner patent. This is equivalent to 3-4 drops of resin, an amount sufficient to repair most stone breaks.

The piston-cylinder injectors of which the one shown in the Werner patent is typical have a number of deficiencies. Most importantly, while they are adequate for stone break repair they are deficient for long crack repair, primarily because they do not hold enough resin. Also, they are susceptible to loosing seal when the piston is backed-off too far; and they are difficult to manipulate with the ease and precision desired for long crack repair. The piston cylinder injectors described in the Campfield patents solved this problem.

The background art discussed above was designed for repairing stone breaks rather than long cracks (over six inches). Stone breaks are seen as small breaks with a chip on the surface of the glass and are called a bullseye, a star-break, a combination bullseye and star break, and sometimes as variants on these configurations. It is well known that stone breaks are “un-surfaced” that is they extend below the surface of the glass; or if they do extend to the surface they are so tight that they must be treated as un-surfaced when being repaired. Thus the prior repair methods and equipment employ application of vacuum at an entry location which is the impact spot which caused the damage, followed by injection of resin under pressure to flow into the crack. This is called “stone damage art”. In this manner, the resin replaces the air in the break. However, stone damage art cannot be used to repair cracks which are “surfaced”, that is where the crack is open at the surface of the glass. Such cracks have been consistently referred to in the art as over 6 inches in length. There was an inability to effectively repair cracks over 6 inches prior to U.S. Pat. No. 5,116,441 to Campfield and U.S. Pat. No. 5,425,827 to Campfield. Stone damage art employs resin viscosity normally in the range of 10 30 c.p.s., but not exceeding about 50 c.p.s. In general the viscosity must be low enough to easily flow in the tight cracks around a stone break. Thus a thin watery viscosity has been desired.

Most long cracks have an end which terminates at a location on the glass area which is neither the edge nor the point of impact. This termination location is called a “point”. The point itself is very tight and locally may be un-surfaced. Further, most such long cracks will extend from a point to the edge of the glass with an impact location usually within two inches of the edge. Other such long cracks will radiate from an impact location to the glass edge or to a point. Frequently the crack will extend in two opposite directions from an impact point, ending in a point in one direction and at an edge in the other direction. Some cracks terminate at a point at each end called a floater crack. Sometimes a Y formation will appear. A surfaced crack will usually be un-surfaced immediately proximate to a point.

Various resins have been in use and introduced in the field of windshield repair from the early 1970's. Most of the resins, as noted above were designed to repair stone breaks and were of low viscosity. Resins up to about 90 c.p.s. were recommended for use in hot weather, although this implies a much lower viscosity when applied to a repair as heat dramatically reduces viscosity. Until 1990, despite some attempts to do so, the repair of cracks over 6 inches in length was generally considered unsuccessful, and was disclaimed or discouraged because the stress was to great for the resin to withstand. Therefore, crack repair was limited to 6 inches until introduction by Campfield, Ultra Bond, Inc. of the method disclosed in U.S. Pat. No. 5,116,441 and later Campfield patents as listed above.

Although in general it has been understood, as explained herein, that a resin having as high viscosity as possible should be used in the various portions of a long crack, there is a disadvantage in using very high viscosities in cold weather—the wetting of the glass and the resistance to flow. For example, while one end of a crack may call for 20-60 c.p.s. resin, the other end may call for 2,000-4,000 c.p.s. In order for these structural adhesives to work a lower compatible resin is first injected as a primer to wet the glass. Then the higher viscosity resin is injected pushing out the primer resin from the center section of the gap and leaving the primer resin along the glass surface as described in Campfield U.S. Pat. No. 5,512,116. This is the only double injection process used by the windshield repair industry to increase the bond and it is specific to a long crack off the edge, called an edge crack. This process is ineffective when there is contamination in the crack that is cross linked to the glass.

The most problematic of contaminants is a hydrophobic coating applied to the surface of the windshield (the outerlite). One such product is called Rain-X sold by SOPUS Products of Houston Tex. Other products are often applied to the outerlite of a windshield for various purposes such as windshield washing fluids, car washing solvents, waxes and bug remover gel. These products are applied in liquid or gel form and they leave a residue on the windshield, and many are of hydrophobic chemistry.

Such products tend to contaminate any surfaced portion of a break in a windshield and they can also get into unsurfaced portions such as a stone break from the impact point. Such contamination of stone-breaks and cracks almost always is from a liquid or it is carried into the break or crack by a liquid. Dirt and dust on the windshield can also be carried into breaks and cracks by rain and windshield wipers. The worst and most difficult contaminates to a windshield repair resin are hydrophobic coatings, in particular the widely used Rain-X product. The problem of Rain-X was brought to the attention of the National Glass Association's National Windshield Repair Committee by committee member Richard Campfield. This committee consisting of windshield repair manufactures, politicians, technicians, and chemists took on the task of solving this problem. The committee found that:

“Rain-X consists of ethanol (1-10%), isopropyl alcohol (75%-95%), polysiloxanes, and organosilanes. An organosilane molecule has two ends—the “silane” end electronically bonds to surfaces like glass. Such a bond is not easily broken—organosilanes can only be removed mechanically, by polishing with an abrasive. products like ClearVue will not completely strip RainX from glass, though it will thin it down somewhat. The “organofunctional” end both links with other siloxanes molecules, and serves an application-specific purpose: in this case creating a hydrophobic surface that repels water. The polysiloxanes promote crosslinking (applying a better film). If the windshield is treated after the damage occurs there is nothing that can be done to restore the loss long term until someone creates a repair resin that loves to bond to the new chains created by the Rain-X. Not likely.”

The committee could find no solution to the problem and abandoned the issue in 2006 stating that windshields contaminated with Rain-X would have to be replaced. Richard Campfield then contacted the chemists at Rain-X (owned by PennZoil-Quaker State, a subsidiary of Shell) informing them of the problem and asking them for a solution to the problem. The Shell chemists reported back that there was no way to remove Rain-X from inside a break or crack in a windshield.

Another way of describing the action of the RainX product follows. The organic silane molecules employed in rain-x are reactive with glass, and also are repellent of water residue. These organo silane derivatives have a lipophillic end, and a electrophilic reactive end. The lipophillic end is comprised of hydrophobic groups such as alkyl groups, covalently bound to the silicon atom at the center of the molecule. The electrophillic end of these organosilanes react with glass, irreversibly binding and thus almost impossible to remove. Most likely explanation is that the electrophillic portion of the organosilane undergoes a substitution reaction with the nucleophillic oxygen moieties that are present to a high degree on the surface of glass. This is an irreversible attachment.

This background established the motivation and need to find a solution to the introduction of contaminants into windshield cracks, which contaminants interfere with repair of cracks; in particular hydrophobic contaminants.

Another problem in the windshield repair industry is that the there has never been a means to pretreat the surfaces in a break or crack in order to improve adhesion of the repair resin to the surfaces.

### DETAILED DESCRIPTION

Contamination is one of the major obstacles to a windshield repair. Most contaminants are liquid or are carried by liquids into breaks and cracks. The windshield repair industry has never been able to pre-treat the crack surfaces in order to increase the bond to the glass because in the case of unsurfaced cracks, the crack surfaces being bonded are not accessible because they are sub-surfaced and in the case of a crack that is surfaced the gap is 0.0001-0.005 in. wide.

The present invention is based on the realization that mechanical means are ineffective to remove contaminants since chemicals such as RainX are resistant to any mechanical methods for removal, and in any event it is not possible to employ a mechanical means in a break or crack. Therefore the invention is based on the realization that any effective way to clean a break or crack surfaces must be by chemical means. Also, a successful method would require that anything injected into the break or crack must not leave behind a residue that would contaminate the resin or other wise interfere with the action of the resin in adhesion to the crack surfaces. In particular in windshield repair it is critical that the repair be clear.

The following description of the present invention has solved that problem, and unexpectedly, it has been discovered that the same method developed for the removal of contaminants, particularly hydrophobic contaminants has led to the added benefit of a method of pretreating the surfaces of a crack to improve bonding or adhesion of the repair resin to the cracked windshield glass, thus enhancing the repair qualities.

In recent years hydrophobic coatings for windshields have become popular. These coatings improve driver visibility by causing rain to roll off the windshield and minimize the use of windshield wipers. The most widely used of these hydrophobic coatings is called Rain-X and is also the most problematic. Rain-X is also now in windshield washer fluids and car washes so it can be on the windshield without the owner knowing it has been inadvertently applied. The hydrophobic coatings molecularly bond to the glass and place a positively charged two-sided molecule on the glass. This bond is very hard to break or remove other than by manual scrubbing with an abrasive solvent such as Soft Scrub. It bleeds when the windshield wipers are used. These molecules will bleed into breaks and cracks in windshields or are directly deposited by the car wash or windshield washer fluid being sprayed. These molecules then bond to the glass surfaces inside the breaks and cracks and block a windshield repair resin from cross linking to the glass, rendering the windshield un-repairable and causing the consumer to have to replace and buy a new windshield instead of an inexpensive windshield repair.

The present invention results from the realization that the solution to the problem must be a chemical solution that will both release the hydrophobic contaminant and will carry it out of the crack.

It has also been determined that the chemical mixture formula that will remove the hydrophobic contaminant and not leave behind a residue has to be an acid that is corrosive to glass but not be corrosive to the PVB layer between the glass layers.

The solution to the problem is a chemical solution, based on the discovery that a mixture of hydrogen fluoride and isopropyl alcohol will completely and effortlessly remove essentially all the Rain-x residue from the surfaces of the cracks in windshields, thus rendering the windshield in condition for facile repair using methods well known to the art of windshield repair.

Isopropyl alcohol is chosen as the solvent of choice in a preferred embodiment of the present invention, since it will evaporate and not leave a residue that contaminants windshield repair resin. however the present invention anticipates that other suitable solvents exist, such as ethanol, methanol, sec butanol, and others of similar boiling points. Upon evaporation it will carry with it the released hydrophobic contaminants, as well as other contaminants that may be in the crack. Acids that are corrosive to glass and not the PVB plastic are hydrofluoric acid or its derivative ammonium bifluoride. This mixture has never been used by the windshield repair industry. These two chemicals were not found to be in the same mixture in a search of 3.5 million Material Safety Data Sheets.

Unexpectedly, when this pretreatment is applied it has been found that it etches the glass at the crack surfaces which increases the mechanical bond of the resin/adhesive to the glass. Therefore, the mixture does two advantageous processes; removes contaminants and increases the mechanical bond of the repair resin to the glass.

In the testing reported a 48% hydrofluoric acid solution was used. As will be appreciated by those skilled in the art, hydrofluoric acid is a solution of hydrogen fluoride in water, by weight. However there is no absolute standard for the concentration of hydrogen fluoride in water to define hydrochloric acid, although the most common commercial solutions are from 48% to 52%. Consequently, it is necessary when describing the amount of hydrofluoric acid in solvent in this invention to convert it to a generic description. The description selected is to define the amount of hydrogen fluoride present as hydrofluoric acid. In this case, the range of 1% to 10% of 48% hydrofluoric acid from the following test is converted to about 0.5% to about 6% by weight of hydrogen fluoride present as hydrofluoric acid. Alternatively it can be defined as an amount of hydrofluoric acid equivalent to the given percentage of 48% hydrofluoric acid in solution with a solvent.

A piece of glass was used for the testing. The solution of isopropyl alcohol and hydrofluoric acid in each test was applied to the glass surface and allowed to dry. Then a standard windshield repair resin was applied to the area. The following chart is a record of testing. The observational results were:

1) The quality of adhesion of the resin to the glass. After the resin was cured its strength of adhesion to the glass was tested by scrapping with a tool. In the test in which no pretreatment was applied, the resin came off easily in one piece. In the tests using increasing concentration of hydrofluoric acid, the resin adhered better as the amount of acid increased as evidenced by increasing difficulty in scrapping it off the glass.

2) Clarity of the resin and adjacent glass surface to which it was adhered. In general as the concentration of hydrofluoric acid increased, the amount of white residue left on the glass increased and then the amount of white coloration of the resin increased seen as decreasing clarity of the resin.

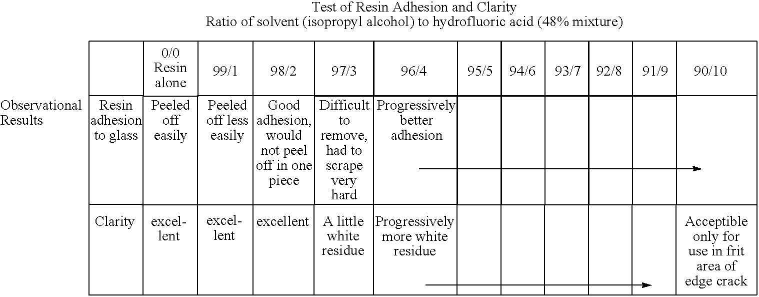

A series of use of the invention in actual windshield repairs is reported below. In these tests two solutions were standardized. The first pretreatment solution is 1 ounce of hydrofluoric acid (a 48% solution) to 14 ounces of isopropyl alcohol. This higher concentration solution is regarded nominally as a 7% solution. The second pretreatment solution is 1 ounce of hydrofluoric acid (48% solution) to 30 ounces of isopropyl alcohol. This lower concentration solution is regarded nominally as a 3% solution. However, since a 48% hydrofluoric acid solution was used, the amount of hydrogen fluoride present as hydrofluoric acid is nominally half (treating 48% as nominally 50%) of the percent of hydrofluoric acid in the pretreatment solution.

Repair 1.

The repair was for a star break. The pretreatment used was 1 ounce of hydrofluoric acid (48% HF) with 14 ounces of isopropyl alcohol. It was applied to the break by injection with a windshield repair tool. It was allowed to dry for about 2-3 minutes. Heat was applied by a heat gun for about 15 seconds. Then repair resin was inserted in a normal windshield repair method. The result was an excellent repair.

Repair 2.

The repair was for an edge crack about 14 inches long which had no stone break portion, just a pinhead impact in the frit area. Two pretreatment solutions were used. In the frit area a solution of one ounce of hydrofluoric acid (48% HF) with 14 ounces of isopropyl alcohol (referred to as the 1/14 solution). In the balance of the crack the pretreatment solution used was one ounce of hydrofluoric acid (48% HF) with 30 ounces of isopropyl alcohol (referred to as the 1/30 solution). The “point” was drilled as per normal windshield repair procedure. The pretreatment solutions were injected and allowed to dry for about 2 minutes. Heat was applied for about 30 seconds. Then, repair resin was inserted as in a normal windshield repair method. The result was an excellent repair. Any white residue from the higher concentration solution was hidden by the frit.

Repair 3

The damage was a stone break, a combination break. The customer was asked about any film on the windshield and reported the use of RainX. The pretreatment solution used was the 1/30 solution described above. The pretreatment was injected, allowed to dry and heated for 15 seconds. Then, the normal repair procedure was followed, injecting resin and curing the resin. The result was an excellent repair.

Repair 4

The damage was a long edge crack about 10 inches long. The windshield appeared dirty along with snow. The repair procedure used was the same as in Repair 2 above and the result was an excellent repair.

Repair 5

The damage was a floater. RainX was on the windshield. The pretreatment used was the 1/30 solution. The result was an excellent repair.

Following are the particulars for carrying out the invention.

The invention is used in the course of repairing a break or crack in a windshield. It can also be used for adhering glass to any other material including another piece of glass. In the windshield repair field The term “break” is intended to refer to stone breaks or stone damage as known in the field and described above. The terms “crack” or “long crack” is intended to refer to long cracks, also as known in the field and described above. In some cases the word “crack” may be used in a more general sense, as the context will make clear, for example, the “crack surfaces” in either a stone break or a long crack refers to the surfaces in the glass that will be adhered to the repair resin.

The first step in repairing a windshield break or crack is to remove contaminants from the crack surfaces in the break or crack. It is appreciated that most cracks are associated with a break. It is also appreciated that the most troublesome contaminants are the hydrophobic chemicals that have been applied to the windshield, which have entered the break or crack and are on the surfaces to which the repair resin will adhere in the course of the repair.

The first step is to prepare the pretreatment solution to remove hydrophobic chemicals from the crack surfaces. the pretreatment solution is a preferred embodiment of the present invention, and its preparation is as follows. a commercially available (Aldrich) aqueous solution hydrofluoric acid (48%) was added slowly to isopropyl alcohol under ambient conditions. The final concentration of the hydrofluoric acid (HF_{(aq)}) in the resulting solution was from between 0.1% to 5%, preferably from about 0.3% to about 4%, and most preferably from about 0.5% to about 2.5%. it is to be understood that ammonium bifluoride may be used in addition to, or for a substitute for hydrofluoric acid. It has also been discovered that the least amount of hydrofluoric acid, the better since higher concentrations of hydrogen fluoride in the pretreatment mixtures have been shown to leave a residue, but at concentrations of the hydrofluoric acid and ammonium bisulfide at less than 1%, the residue does not affect the resulting clarity of the repair. Greater concentrations and in particular concentrations over about 5% work insofar as removal of the contaminant, but at around 5% the white residue will change the refractive index or clarity of the resin thereby resulting in an unacceptable repair for a windshield. Amounts over 5% can be used for other glass adhesive applications (other than windshields) where clarity is not a issue.

The hydrofluoric acid only has to be a minimum of approximately less than about 1% of the pretreatment mixture. Mixtures above 1% can also be used but over 5% leaves behind a white residue that can change the refractive index of the clear resin.

After it is prepared, the pretreatment solution is then injected into the break or crack (or both). This can be done by any convenient means. However it is important that the pretreatment solution not be allowed to go onto the windshield surface, or if some of it does, that it be wiped off promptly, before it etches the surface.

For a windshield repair the chemical pretreatment solution of the present invention can be applied by injecting: with a windshield repair injector/tool; by capillary action; by syringe or any other means that will force the chemical solution into the break or crack. The chemical pretreatment solution will react with the contaminant (RainX, etc.) on the surface of the glass crack thus causing a quick release the hydrophobic contaminants from the glass crack surfaces, which usually takes place under ambient conditions in less than 5 minutes since the products of the pretreatment cleaning reaction of the present invention are volatile after about at least 1 minute it may be advantageous to add heat to facilitate this evaporation of the volatile products which include the organosilane hydrophobic contaminants. After the solution has been evaporated the repair process can then be performed as it normal is done.

Additional chemicals can be beneficially added to the pretreatment solution to enhance the cleaning effect. One such example is acetic acid which may be added to the pretreatment cleaning solution from between about 0.1% to about 5% most preferably about 1%.

Another preferred alternative to the present invention is the incorporation of the acrylic acid in the pretreatment solution. Acrylic acid may be added from about 0.1% to about 2.5% most preferably about 1%. Acrylic acid is added to help increase the strength of the binding between the resin and the cracked portions of the windshield glass.

However it is important to note that these two chemicals, acetic acid and acrylic acid cannot be combined together in a final preparation of the pretreatment solution because when combined they leave behind a residue that causes cloudiness in the repair.

Generally, after the pretreatment step has been completed, the windshield repair can proceed as in the prior art.

The pretreatment method and compositions of the present invention when practiced in accordance with the procedures outlined above will result in a significantly improved windshield repair. The significant improvement is due to improved strength in adhesion of the repair resin to the glass. The pretreatment will also improve the resin adhesion of other glass bonding adhesive applications. These include windshield replacement/installation, and in particular the process described in U.S. Pat. Nos. 5,653,497 and 5,860,689. This process, is commercialized under the trademark Edgeguard by Ultra Bond, Inc of Grand Junction Colo. The process appreciates that impact near the edge of a windshield nearly always result in an edge crack. An edge crack is more severe than other cracks in windshields, and therefore the Edgeguard material and process is designed to protect against edge cracks. In this process an impact absorbing barrier is applied to the windshield around its peripheral area, such as up to 4 inches from the edge. Typical impact absorbing materials are polyester film material which applied as film or sprayed on to form a film. Secure application of the Edgeguard film is subject to degradation from the presence of hydrophobic chemicals on the windshield. For this use, the p[retreatment mixture is applied, such as by brushing on with a dabber, before applying the adhesive or primer for the normal Edgeguard process. After the pretreatment is applied, it is allowed to dry so that the volatile components will evaporate. The evaporation can be aided by heating as explained above.

The foregoing Detailed Description of exemplary and preferred embodiments is presented for purposes of illustration and disclosure in accordance with the requirements of the law. It is not intended to be exhaustive nor to limit the invention to the precise form or forms described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising step(s) for . . . ”

1. The method of removing contamination from a break or crack in a windshield by injecting the break or crack with a mixture of hydrofluoric acid or ammonium bifluoride and isopropyl alcohol.

2. The method of claim 1 where in the contaminant is a hydrophobic coating.

3. The method of claim 1 wherein the mixture contains from less than 1% to about 5% of the hydrofluoric acid or ammonium bifluoride.

4. The method of claim 1 wherein other contaminant removal and further cleaning is accomplished by adding acetic acid to the mixture.

5. The method of increasing the adhesive mechanical bond for the repair of a break or crack in a windshield by first injecting a pretreatment mixture of hydrofluoric acid or ammonium bifluoride and isopropyl alcohol into the crack and allowing it to evaporate whereby the crack surfaces will be etched.

6. The method of claim 5 wherein the mixture contains from less than 1% to about 5% of the hydrofluoric acid or ammonium bifluoride.

7. The method of claim 5 wherein the bond of the repair resin used for the repair is also increased by adding acrylic acid to the pretreatment mixture.

8. The method of pre-treating any glass adhesive application by first applying a mixture of hydrofluoric acid or ammonium bifluoride and isopropyl alcohol to at least one of the surfaces to be adhered in order to increase the bond of the adhesive used in the adhesive application

9. The method of claim 8 wherein the glass adhesive application is a windshield installation.

10. A method for repairing a windshield damaged by a crack or break resulting in cracked surfaces in the windshield comprising;
applying a pretreatment solution to the cracked surfaces which pretreatment solution comprises hydrofluoric acid and a solvent;
allowing the pretreatment solution to dry;
repairing the crack or break by the injection therein of a repair resin.

11. The method of claim 10 wherein the pretreatment solution comprises hydrofluoric acid in a concentration measured as equivalent to about 1% to about 10% hydrofluoric acid (48%).

12. The method of claim 10 wherein the solvent is isopropyl alcohol.

13. The method of claim 10 further wherein the pretreatment solution comprises acetic acid.

14. The method of claim 10 further wherein the pretreatment solution comprises an acrylic acid.

15. The method of claim 10 wherein the pretreatment solution comprises about 0.5% to about 6% hydrogen fluoride as hydrofluoric acid.

16. A method of pretreating a windshield crack or break to remove hydrophobic contaminants and also to improve the surfaces for adhesion of repair resin comprising;
applying a pretreatment solution to the cracked surfaces which pretreatment solution comprises a chemical that will break a bond between the glass and the contaminant and will also etch the glass and a solvent;
allowing the pretreatment solution to dry and to volatilize the hydrophobic contaminants and to render the glass surfaces etched;
repairing the crack or break by the injection therein of a repair resin.

17. The method of claim 16 wherein the chemical is hydrogen fluoride or hydrofluoric acid or ammonium bifluoride or derivatives thereof.

18. The method of claim 17 wherein the solvent is isopropyl alcohol.

19. The method of claim 17 wherein the chemical is about 0.5% to about 6% hydrogen fluoride as hydrofluoric acid.

20. The method of claim 16 further wherein the pretreatment solution contains either acetic acid or acrylic acid.

21. The method of claim 17 wherein the windshield has an edge crack and two different pretreatment solutions are used, a first such solution having a relatively high concentration of hydrofluoric acid placed in the portion of the crack near the edge where a frit is present and a relatively lower concentration in the balance of the crack.

22. The method of claim 21 wherein the relatively high concentration is defined as about 1/14 and the relatively low concentration is defined as about 1/30
